(19) United States
(12) Patent Application Publication
(10) Pub. No.: US 2010/0064212 A1
(43) Pub. Date: Mar. 11, 2010

(54) Electronic Device Having a User Input Interface Opposite a Display

(75) Inventor: Thomas D. Snyder, Cary, NC (US)

Correspondence Address: COATS & BENNETT/SONY ERICSSON, 1400 CRESCENT GREEN, SUITE 300, CARY, NC, 27518, US

(73) Assignee: SONY ERICSSON MOBILE COMMUNICATIONS AB, Lund (SE)

(21) Appl. No.: 12/208,816

(22) Filed: Sep. 11, 2008

(51) Int. Cl. G06F 3/00

(52) U.S. Cl. 715/700

(57) ABSTRACT

A consumer electronic device, such as a cellular telephone, includes a monolithic housing. A display is positioned on a first face of the housing and displays graphics to the user. An input interface, such as a keypad, for example, accepts user input and is positioned on the opposing back face of the housing. The display and the interface are oriented in opposing directions, and the display overlays an image of the input interface over the displayed graphics to allow a user to view which keys the user presses.

### TECHNICAL FIELD

The present invention relates generally to electronic devices, and particularly to electronic devices having user input interfaces positioned to optimize user input efficiency.

### BACKGROUND

Mobile electronic devices, such as cellular telephones and Personal Digital Assistants (PDAs), are very common. In terms of performance, modern devices are fast approaching the performance provided by more traditional computing devices such as laptop computers. This allows manufactures to pack their mobile devices full of functions and features that allow a user to communicate voice and data with remote parties, play music, capture images, and render videos. Additionally, most devices now permit the user to create, send, and receive e-mail, as well as access web pages on the Internet from almost any location, which is especially popular.

With traditional electronic devices, the user input interface and the viewing screen or display necessary to use such features are positioned on the same face of the device. This allows a user to view the display while inputting data. Although this facilitates usability, it also makes designing the device more difficult. Particularly, there is a limited amount of space available on the device to position the display and user input interface. Therefore, manufacturers generally decrease the size of the display and/or the user interface, or increase the size of the device by placing them on separate housings. Although consumers need these components to operate the device features, they generally are not willing to accept smaller displays and interfaces, or large, bulky devices.

### SUMMARY

A consumer electronic device, such as a cellular telephone, comprises a display and a user input interface on opposing sides of the device housing. The display is positioned on a front face of the housing and displays graphics to the user. The user input interface, which may be a keypad or other user controls, for example, is positioned on the opposing back face of the housing. The display and the interface are oriented to face in opposite directions, and thus, a user would not be able to view both the display and the user input interface at the same time. Therefore, the present invention may also overlay an image of the input interface over the graphics shown on the display. This allows a user to identify the positions of the keys and user controls on the back face as the user views the display.

In use, the user holds the consumer device to view the display. The user would then depress or actuate desired keys and controls on the user input interface on the back side of the housing while viewing the display. As the user actuates an actual key or control, the corresponding character or action occurs on the display. In one embodiment, however, the overlay image of the corresponding key or control also changes to indicate that the key or control is depressed or actuated.

### BRIEF DESCRIPTION OF THE DRAWINGS

FIGS. 1A-1B are perspective views illustrating the front and back, respectively, of a consumer electronic device configured according to one embodiment of the present invention.

FIG. 2 is a perspective view illustrating a consumer electronic device that displays an overlay image of a user input interface according to one embodiment of the present invention.

FIGS. 3A-3B are perspective views illustrating the front and back, respectively, of a consumer electronic device configured according to another embodiment of the present invention.

FIGS. 4A-4B are perspective views illustrating the front and back, respectively, of a consumer electronic device configured according to one embodiment of the present invention.

FIGS. 5A-5B are perspective views illustrating the front and back, respectively, of a consumer electronic device configured according to one embodiment of the present invention.

FIGS. 6A-6B are perspective views illustrating the front and back, respectively, of a consumer electronic device configured according to one embodiment of the present invention.

FIGS. 7A-7B are perspective views illustrating the front and back, respectively, of a cellular telephone configured according to one embodiment of the present invention.

FIGS. 8A-8B are perspective views illustrating the front and back, respectively, of a cellular telephone configured according to another embodiment of the present invention.

FIG. 9 is a block diagram illustrating some of the component parts of a consumer electronic device configured according to one embodiment of the present invention.

### DETAILED DESCRIPTION

The present invention positions a user input interface on a mobile electronic device to optimize the efficiency with which a user can enter data and operate user controls. In one embodiment, a consumer electronic device comprises a housing having a front face and an opposing back face. A display is positioned on the front face of the housing and displays web pages and other graphics for a user. A user input interface is positioned on the back face of the housing and accepts user input. The display and the user input interface are oriented to face in opposite directions and, thus, the user is not able to directly view both the display and the user input interface at the same time. Therefore, the present invention may overlay an image of the user input interface as a faint outline over the graphics on the display. The overlay corresponds to the placement of the keys or controls that comprise the user input interface on the back face of the housing. The overlay provides an accurate visual cue to the user of the location of the keys or controls, as well as which key or control is being actuated. This allows the user to enter data, interact with applications executing on the device, or otherwise control the functions of the mobile electronic device “blindly” (i.e., without viewing the user input interface directly).

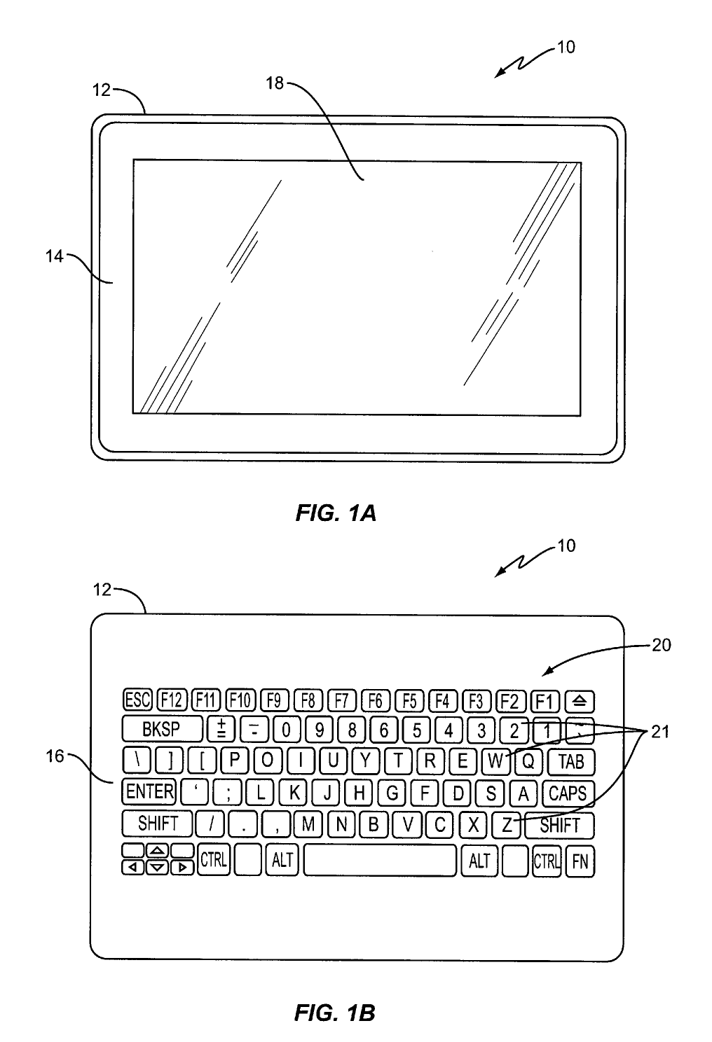

FIGS. 1A-1B illustrate opposing front (FIG. 1A) and back (FIG. 1B) faces of a consumer electronic device 10 configured to operate according to one embodiment of the present invention. As seen in FIGS. 1A and 1B, device 10 comprises a portable electronic device that is sized to fit within a user's hand. Some examples of suitable devices 10 include, but are not limited to, Personal Digital Assistants (PDAs), calculators, and, as seen in later figures, wireless communication devices such as cellular telephones and satellite telephones.

Device 10 comprises a device housing 12 having a first face 14 and an opposing second face 16, a display 18, and a user input interface 20. In one embodiment, the housing may comprise a single unitary housing. In other embodiments, the housing may have separate sections that pivot, slide, rotate, or otherwise move with respect to one another. In addition, for clarity only, the first and second faces 14, 16 are referred to herein as the “front” and “back” faces 14, 16, respectively. The front face 14 typically faces in a first direction (i.e., towards the user), while the back face 16 faces the opposite direction (i.e., away from the user).

Display 18 is positioned on the front face 14 of device 10 and may comprise, for example, a Liquid Crystal Display (LCD) or a touch-sensitive display. According to the present invention, the display 18 covers substantially the entire surface of the front face 14 to allow the user to easily view videos, images, statuses, menu options, and other service information. In embodiments where device 10 is a communications device, the display 18 may also display dialed digits, caller ID information, web pages, and email application graphics that allow the user to send and receive messages via a wireless communication network. In cases where device 10 includes a camera (not shown), the display 18 also functions as a viewfinder to permit the user to view the subject of an image before capturing the image.

The user input interface 20 is positioned on the back face 16 of device 10, and substantially covers the back face 16. Although the user input interface 20 can comprise any known user input mechanism, the embodiment of FIGS. 1A-1B illustrate the interface 20 as a full QWERTY keyboard having a plurality of keys 21. The keys 21 typically include alphanumeric keys that allow the user to enter text data, but can also include controls that permit the user to navigate menus, select menu options, interact with executing applications, and otherwise control the functionality of device 10. The keys 21 may be arranged in any desired order; however, as described in more detail below, the keys 21 are generally arranged on the back face 16 such that they present a “mirror image” of a conventionally arranged keyboard when viewed from the front face 14. This arrangement permits a more accurate positional correlation between the overlay of the user input interface on display 20 and the physical location of the keys or controls on the back face 16.

The display 18 and the user input interface 20 are, according to the present invention, positioned on opposing faces of the housing 12 such that they face in opposite directions. This allows the present invention to maximize the size of both the display 18 and the interface 20. However, this particular layout also makes it very difficult for the user to view the user input interface 20 while looking at the display 18. Because the user cannot view both the interface 20 and the display 18 simultaneously, the user enters text data and operates the interface user controls “blindly.” Therefore, the present invention may also overlay a translucent image of the interface 20 over the graphics that are generally displayed on display 18 to allow the user to view both the graphics and the keys 21 of the user input interface 20.

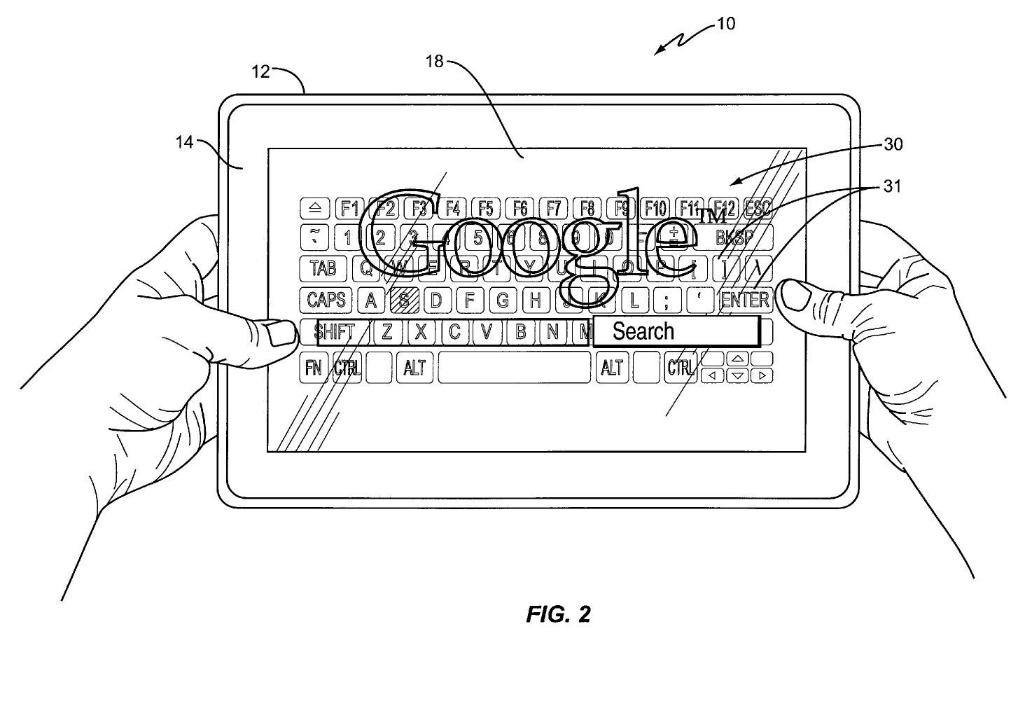

As seen in FIG. 2, for example, a web page from the GOOGLE internet search engine is displayed on display 18. A translucent overlay image 30 is also displayed as a faint outline on display 18. The overlay image 30 comprises key images 31 that correspond to the actual keys 21 of interface 20. The outline of each key image 31 is displayed such that it indicates the location of the actual keys 21 on the back face 16. Thus, the overlay image 30 is a mirror image of the keyboard. This mirror image provides the user with visual cues as to the physical position of a given key 21 on the back face 16. However, other tactile cues, such as home row bumps and unique sizes or shapes, for example, may also be used to identify keys.

The graphics that comprise the web page are shown in FIG. 2 as having a bold font, while the overlay image 30 is illustrated as being a faint outline. This helps the user to discern between controls that are displayed as part of web page or other graphics and the overlay image 30.

In use, a user holds the device 10 such that the front face 14 and the display 18 are facing the user. One or more of the user's fingers are positioned behind the device 10 such that the user can contact and actuate the keys 21 of the interface 20 on the back face 16. The user may place his or her thumbs on the front face 14 of housing 12 to stabilize the device 10. When the user presses a key 21, the corresponding letter or number appears on the display 18 as if the user had depressed a conventional key on a conventional keyboard. Additionally, however, the present invention changes the appearance of the corresponding key image 31 to indicate that the key 21 was depressed. For example, in the embodiment of FIG. 2, the “S” key is highlighted to indicate that the user has depressed the “S” key. When the user releases the key 21, the highlighting of the corresponding key image 31 also ceases.

Similarly, other keys 21 such as the ENTER key, the SHIFT keys, the SPACEBAR key, the number keys, the function keys, and user control keys or interfaces all have corresponding key images 31 that indicate their position on the back face 16 of housing 12. These key images 31 are also highlighted or changed to indicate when the user actuates that key 21. Additionally, combinations of keys and controls are also possible. For example, whenever a user enters a capital “S,” the overlay image 30 is altered to highlight both the SHIFT key and the “s” key.

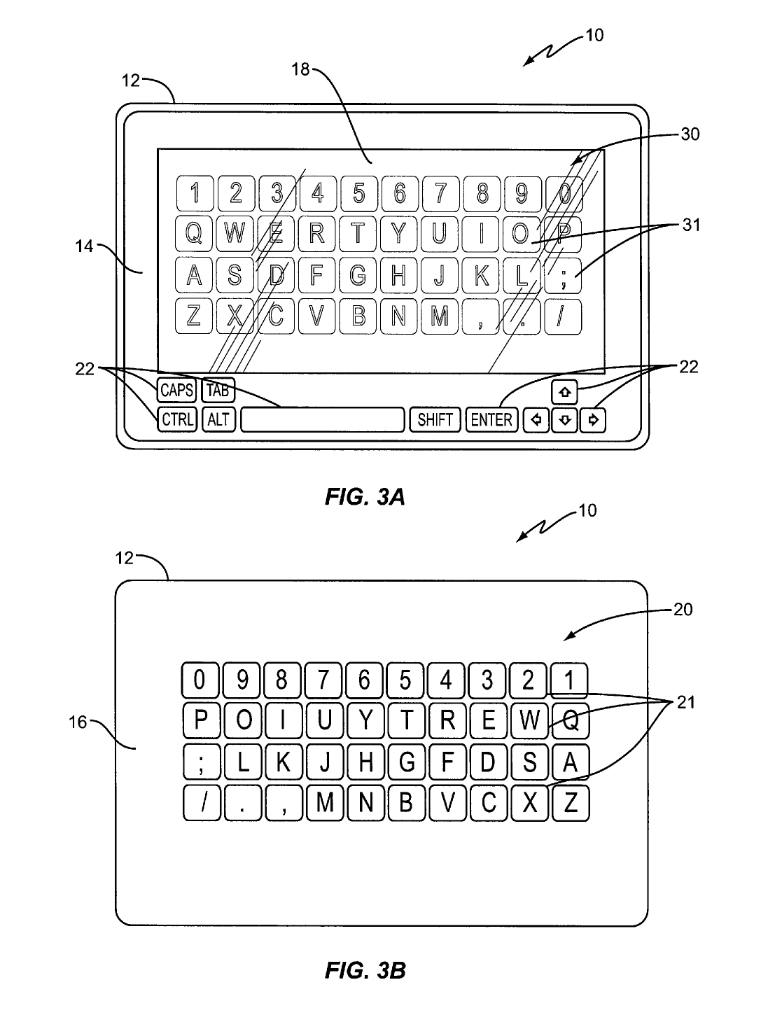

FIGS. 3A-3B illustrates another embodiment of the front (FIG. 3A) and back (FIG. 3B) of the device 10 configured according to another embodiment of the present invention. In this embodiment, the user input interface 20 comprises the alphanumeric keys 21. The keys that comprise the user controls, such as keys 22, are disposed on the front face 14 of housing 12. In this embodiment, the user control keys 22 comprise keys such as the TAB key, a SPACEBAR, the SHIFT key, the ENTER key, and the directional arrow keys. However, other keys may be placed on the front face 14 in addition to, or in lieu of, the illustrated control keys 22 as needed or desired. The embodiment of FIGS. 3A-3B allow the user to access some of the keys of interface 20 with the thumbs while allowing the user to access the remaining keys 21 on the back face 16.

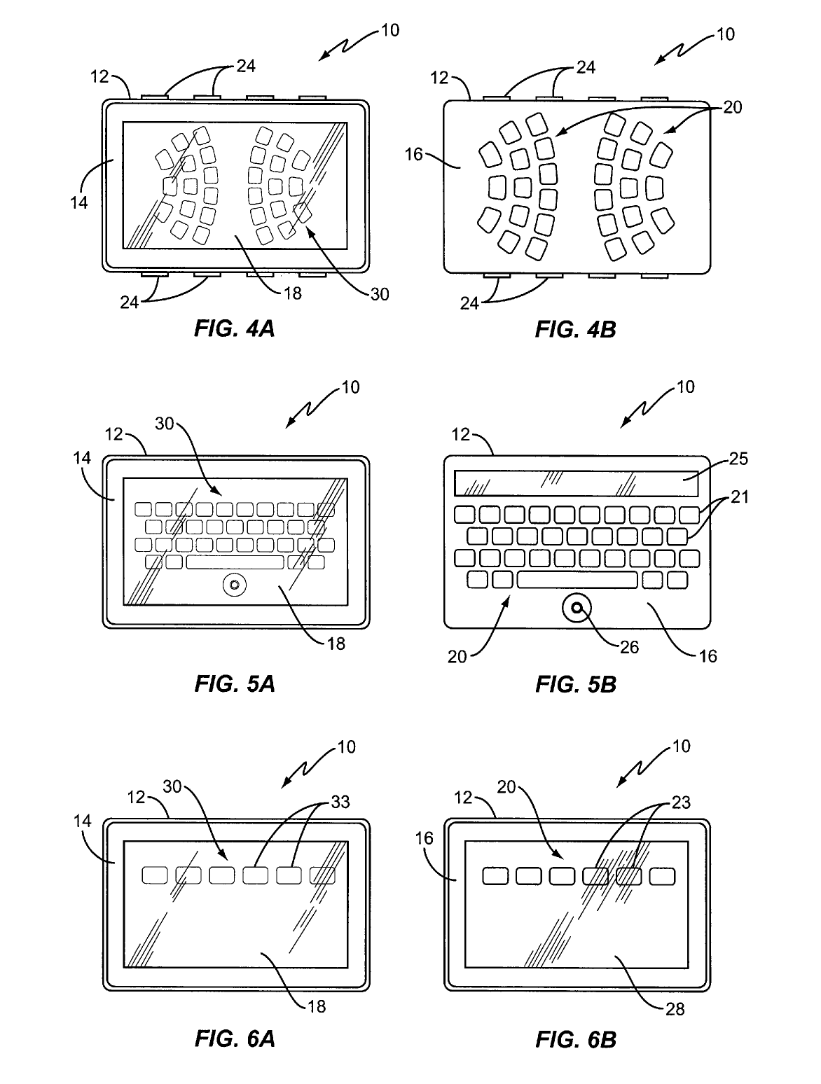

FIGS. 4A-4B illustrates another embodiment of the front (FIG. 4A) and back (FIG. 4B) of the device 10. In this embodiment, the physical user input interface 20 comprises all or some of the keys 21 that make up a QWERTY keyboard. However, instead of a conventional row-column arrangement, the keys 21 are arranged in vertical arcs. The vertical arc arrangement may make it easier for some users to use the interface 20 when holding the device on the sides as was seen in FIG. 2.

In addition, this embodiment places buttons 24 on the periphery of the housing 12. The buttons 24 may be, for example, user control buttons, such as the ENTER key or the SHIFT keys, or may be function keys that adjust the volume or screen brightness and/or display. As with the other embodiments, the overlay image 30 on display 18 is a mirror image of the placement of the actual keys 21 on the back face 16. Whenever a user actuates a given key 21, its corresponding image 31 is highlighted or otherwise altered to indicate that it has been depressed.

FIGS. 5A-5B illustrates the front (FIG. 5A) and the back (FIG. 5B) of an alternate embodiment of the present invention. In this configuration, the interface 20 on the back face 16 of the device 10 comprises a QWERTY keyboard. In addition, however, the interface 20 also includes a small display 25 and a navigational disk 26. The small display 25 could be configured to display the caller ID information associated with an incoming call, for example, or to display the text of an SMS message being sent/received by the user.

In this embodiment, the keys 21 on the back face 16 of housing 12 are arranged conventionally to facilitate readability by the user. Thus, when looking at the back of device 10, the user can view the interface 20, the keys 21, the data on the display 25, and the navigation disk 26 as is conventional. When looking at the front of device 10, the user can view the interface image 30 including the key images 31 and the navigation disk image 36. However, the overlay image 30 in this embodiment would not be a mirror image of the interface 20. Rather, the key images 31 would appear in “reverse” to their corresponding actual keys 21. While such an arrangement does not indicate the positional correspondence between all physical keys 21 and their corresponding key images 31, it allows the user to also view the keys 21 as if they were conventionally arranged regardless of whether the front face 14 or the back face 16 is facing the user.

FIGS. 6A-6B illustrates the front (FIG. 6A) and the back (FIG. 6B) of a consumer electronic device configured according to another embodiment of the present invention. In this embodiment, the interface 20 comprises a touchscreen display 28 having one or more softkey icons 23. Key images 31 of the icons 23 are displayed on the display 18, and indicate the physical location of the softkey icons 23 on the touchscreen display 18. Because the softkeys 23 are programmable, the user interface 20 may be customized in any number of ways to accommodate almost any function. The interface image 30 would also change to display a corresponding image for the interface 20.

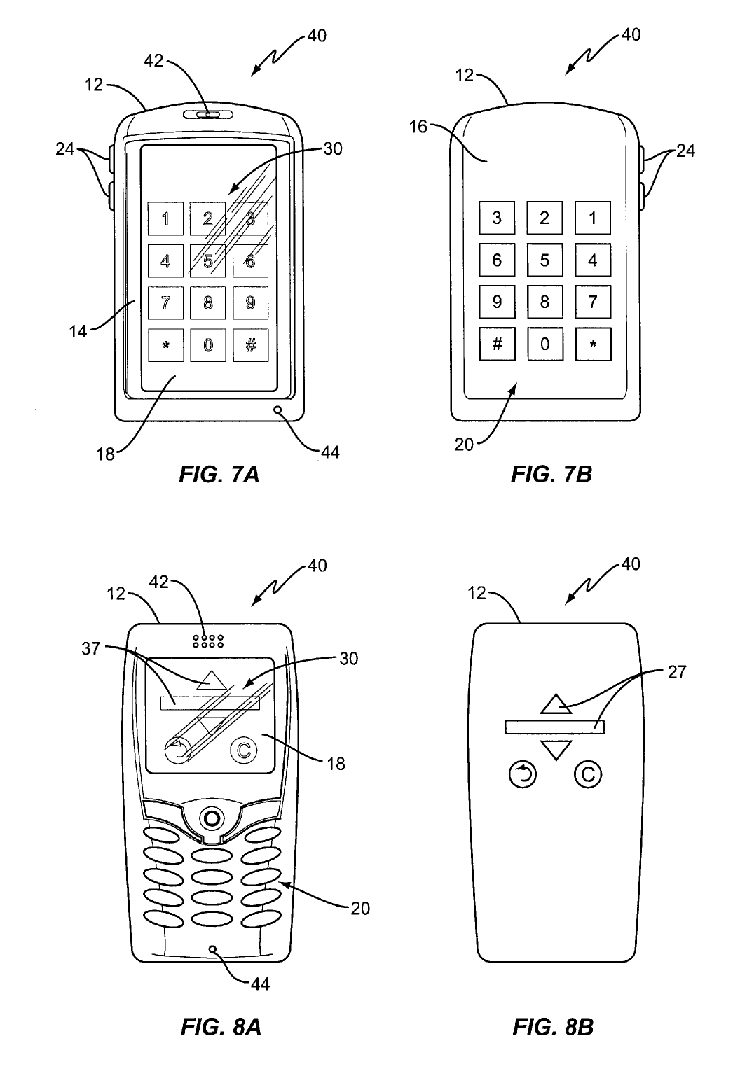

FIGS. 7 and 8 illustrate embodiments wherein the device 10 is a cellular telephone 40. As seen in FIGS. 7A and 7B, the display 18 is positioned on the front face 14 of the housing 12 (FIG. 7A). The user interface 20 comprises a keypad disposed on the opposing back face 16 of housing 12 (FIG. 7B). Because the keypad is on the back face 16, the display 18 can cover substantially the entire front face 14 of housing 12. A speaker 42 renders audible sound from a remote party, for example, and a microphone 44 converts the user's speech signals into audio signals for transmission to the remote party.

As seen in FIG. 7A, the interface image 30 is a mirror image of the numbers on the keypad interface 20. Thus, the user can hold the cellular telephone 40 facing the display while operating the interface 20 as previously described. For example, the user can employ the interface 20 to enter telephone numbers, create/edit text messages, play music, select menu options, and the like, while viewing the display 18. The individual key images in the interface image 30 may be highlighted as previously described to indicate to the user which key was selected.

FIGS. 8A-8B illustrate another embodiment of the cellular telephone 40 wherein the part of the interface 20 containing the numbers is disposed on the front face 14 (FIG. 8A), and the part of the interface containing user controls 27 is contained on the back face 16 (FIG. 8B) of housing 12. The interface image 30 displays a mirror image of the controls 27 and indicates a selected control as previously described.

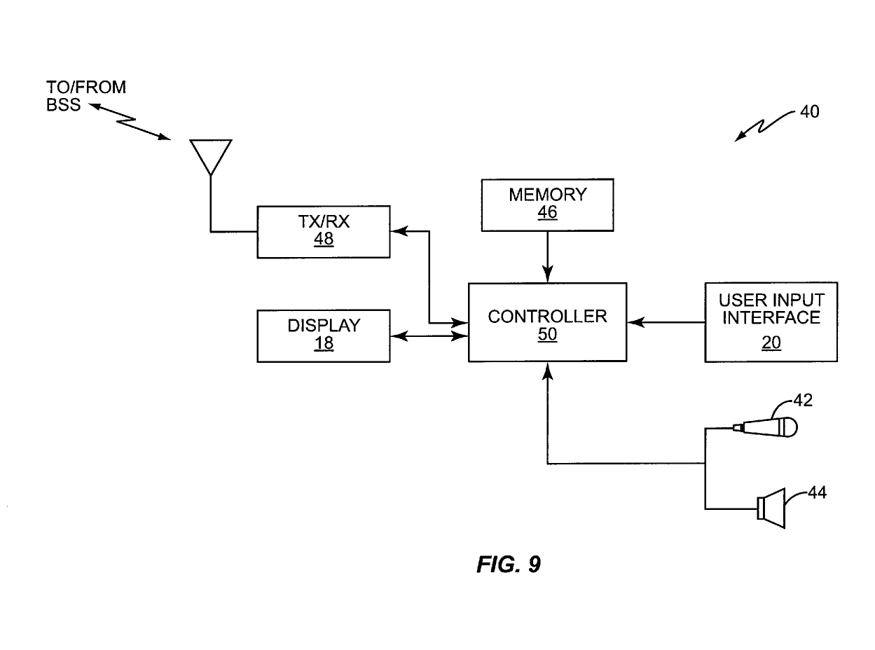

FIG. 9 illustrates a block diagram showing some of the main components of an exemplary consumer electronic device 10 configured according to the present invention. Although device 10 may be any device known in the art, FIG. 9 illustrated device 10 as cellular telephone 40 for clarity.

In addition to the display 18, the user input interface 20, and the speaker and microphone 42, 44, the cellular telephone 40 comprises a memory 46, a communication interface 48, and a controller 46. Memory 48 stores programs and data needed for operation. Communication interface 48 enables the cellular telephone 40 to communicate voice and/or data with one or more remote parties via a wireless communication network. The communications interface 48 may comprise, for example, a cellular transceiver (e.g., GSM, WCDMA, etc.), wireless LAN (e.g., WiFi, WiMAX, etc.) interface, BLUETOOTH interface, other type of wireless interface.

The controller 50 may comprise one or more processors to control overall operation of the cellular telephone 40, and to execute one or more user applications. Some examples of suitable applications include, but are not limited to, email applications, web browser applications, word processing applications, spreadsheet applications, and multimedia applications, such as image and/or video applications and music applications. According to the present invention, the controller 50 is configured to update the display 18 with user input received at the user input interface 20 thereby allowing the user to interact with these applications without having to see the user input interface directly.

According to one embodiment of the present invention, for example, the controller 50 is configured to receive a signal from the user input interface 20 indicating a particular key 21 or other user control that has been actuated by the user. Upon receipt of this input signal, the controller 50 generates a first output control signal to display 18. The first control signal causes the display 18 to update the visual content of the display as appropriate. For example, the display 18 may highlight a menu option, launch a user application, populate a text box with a character or number that corresponds to the depressed key 21, or send/receive an email. Additionally, the controller 50 generates a second output control signal to display 18. The second control signal may cause the display 18 to change the appearance of the corresponding key image 31. For example, display 18 may highlight the key image 31 that corresponds to the actuated key 21. This shows the user which key 21 was pressed. The first and second output control signals may be the same control signal or different control signals.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A consumer electronic device comprising:
a housing having a first face oriented towards a user and a second opposing face oriented away from the user;
a display on the front face of the housing configured to display visual content to a user;
a user input interface having one or more user controls on the second face of the housing, and configured to receive user input; and
a controller configured to update the visual content on the display responsive to receiving the user input at the user input interface.

2. The device if claim 1 wherein the housing comprises a monolithic housing.

3. The device of claim 2 further comprising a transceiver within the housing to allow a user to communicate with a base station in a wireless communication network.

4. The device of claim 1 wherein the display is further configured to display a translucent overlay image of the user input interface indicating the location of the one or more user controls on the second face of the housing.

5. The device of claim 4 wherein the controller is further configured to change an appearance of the image of a user control on the display responsive to the user actuating the corresponding user control on the second face.

6. The device of claim 1 wherein the user input interface on the second face comprises a touch-sensitive display that displays one or more soft-key user controls.

7. The device of claim 1 further comprising one or more user input controls on the first face of the housing adjacent the display.

8. The device of claim 1 further comprising one or more user input controls on the second face of the housing adjacent the user input interface.

9. The device of claim 1 further comprising one or more user input controls on a peripheral edge of the housing.

10. The device of claim 1 further comprising a second display on the second face of the housing adjacent the user input interface.

11. A method of displaying user input on an electronic device, the method comprising:
positioning a display on a first face of a housing of the electronic device to display visual content to a user; and
positioning a user input interface having one or more user input controls on a second face of the electronic device to receive user input, wherein the first face and the second face are oriented to face opposing directions; and
updating the visual content on the display responsive to the user input.

12. The method of claim 11 further comprising displaying a translucent overlay image of the user input interface on the display with the visual content such that the user can view the user input interface with the visual content.

13. The method of claim 12 wherein displaying a translucent overlay image comprises displaying corresponding translucent images for each user input control on the user input interface.

14. The method of claim 13 wherein the translucent overlay image indicates a location of the user input controls on the second face of the device housing.

15. The method of claim 13 further comprising altering an appearance of a translucent image of a user control responsive to the user actuating the corresponding user input control on the second face of the housing.

16. The method of claim 11 wherein the user input interface comprises a touch-sensitive display configured to display one or more soft-key user input controls.

17. The method of claim 11 further comprising positioning one or more user controls on the first face of the housing adjacent the display.

18. The method of claim 11 further comprising positioning one or more user controls on the second face of the housing adjacent the user input interface.

19. The method of claim 11 further comprising positioning one or more user controls on a periphery of the housing.

20. The method of claim 11 wherein the user input interface is oriented to face a first direction, and the display is oriented to face a second direction opposite the first direction.
